(19) United States
(12) Patent Application Publication
(10) Pub. No.: US 2002/0010046 A1
(43) Pub. Date: Jan. 24, 2002

(54) Side to side-back and forth rotary transmission device

(76) Inventors: Chad Nathaniel Kirkland, Birmingham, AL (US); Stacy Rachelle Pate-Kirkland, Birmingham, AL (US)

Correspondence Address: Chad N. Kirkland, 1428 Elizabeth Avenue, Birmingham, AL, 35217, US

(21) Appl. No.: 09/804,763

(22) Filed: Mar. 13, 2001

Related U.S. Application Data
(60) Provisional application No. 60/190,081, filed on Mar. 17, 2000.

(51) Int. Cl. F16H 55/30

(52) U.S. Cl. 474/152

(57) ABSTRACT

The side to side-back and forth rotary device is an alternative mechanism for enabling a device or devices to rotate side to side or back and forth. The collective parts of the said rotary device assembled in the fashion for which it is intended make it new in the art of perpetual motion. It's dependent devices, Electrofloss, Electrobrush, and the sander-buffer represent alternative products in their fields. Electrofloss and Electrobrush can compete against the prior art in the field of dentistry, and the sander-buffer can compete against its competitors in the automotive industry.

### BACKGROUND—FIELD OF INVENTION

This invention relates to any apparatus whose affect is a side to side or back and forth motion.

### BACKGROUND—DESCRIPTION OF PRIOR ART

Many devices exist which move in a side to side or back and forth motion to perform their intended function. Some of these devices are electric dental floss, electric toothbrushes, automobile body buffers, sanders, and sewing machines. Many devices which depend upon a side to side or back and forth motion to perform their intended function can be retrofitted with the side to side-back and forth rotary transmission device. Because of its simplistic nature of design, the said device will be more cost effective to manufacture than that of the prior art.

### SUMMERY OF THE INVENTION

The side to side-back and forth rotary transmission device is a rotary transmission means which can be used to operate any apparatus whose proper functioning is dependent upon a side to side or back and forth motion to accomplish the purpose for which it was intended. One device that can be operated using the side to side-back and forth rotary transmission device is electrically powered, dental floss. The said rotary device could be attached to a two-pronged fork with a piece of dental floss connected across the two forks. Moving side to side, the dental floss would easily clean plaque and debris from the teeth and gums with very little effort on the part of the user. Effortless flossing is not possible with conventional dental floss. The said rotary device could also be used to operate electrically powered toothbrushes. Operating in the same manner as the electrically powered dental floss, the brush head would move in an “up and down” motion when applied to the teeth thereby cleaning the teeth. Another device that could be operated using the said rotary device is an electric sander or buffer. One could incorporate the said rotary device into a closure type device with a flat bottom. This can be accomplished by attaching the said rotary device to a free moving flat bottom. Next, a buffing pad could be attached to the bottom. This device could then be used to buff the paint on automobiles. By attaching sandpaper to the said bottom instead of a buffing pad, one could sand paint or varnish from automobiles or furniture. The electrically powered dental floss, tooth brush, sander, and buffer could use any type of motor previously or presently used by that of the prior art as a power source for operation. By using the side to side-back and forth rotary transmission device to operate a sander-buffer machine, a dual purpose is created. One will no longer have to purchase both an electric sander and an electric buffer. Instead, one can utilize the benefit of purchasing one machine that will perform both sanding and buffing.

### ADVANTAGES

One advantage that the side to side-back and forth rotary transmission device has over the prior art when used to operate electric dental floss, toothbrushes, and the sander-buffer is its simplicity. The fact that it is comprised of few parts ensures a lower manufacturing cost and a higher margin of reliability as well as a higher margin of profit compared to the prior art. In addition, though there are many related prior arts to compete with, the side to side-back and forth rotary transmission device and its said dependent devices will broaden the field of competition. The said rotary device will provide an alternative product choice for consumers as well as enable others not already involved to enter into the market.

### DRAWING FIGURES

FIG. 1 shows a topical view of a back and forth rotary device while in operation. A rotary shaft 22a with rotary bearings 22b attached at the end of the said rotary shaft 22a synchronized with a rotary sprocket 24a are demonstrated in operation within the confines of a circle and an outlying half circle for the purpose of showing the perimeter of operation.

FIG. 2 shows the said rotary shaft 22a with the said rotary bearings 22b in operation. The arrows show the direction of operation of each said part.

FIG. 3 shows the said rotary sprocket 24a in operation. The arrows show the direction of operation of the said rotary sprocket 24a. The said rotary sprocket 24a is not limited to a clockwise direction of operation. By placing the paddles 24b of the said rotary sprocket 24a on the opposite side of the arms of the said rotary sprocket 24a, the said can perform the same function in a counter-clockwise direction.

FIG. 4 shows the said back and forth rotary device in full operation with the arrows showing the direction of each said part.

FIGS. 5 through 16 show some of the variations of FIGS. 1 through 4. The arrows indicate the direction in which each said part is moving when the said device is in operation.

FIGS. 11 and 13 are to be used in conjunction with FIGS. 15 and 6. The bearings in the form of spheres attached to the rotary shaft in FIGS. 6 through 16 will operate equally well if replaced by ball bearings shown in FIG. 5.

### DRAWING FIGURES FOR “ELECTROFLOSS”

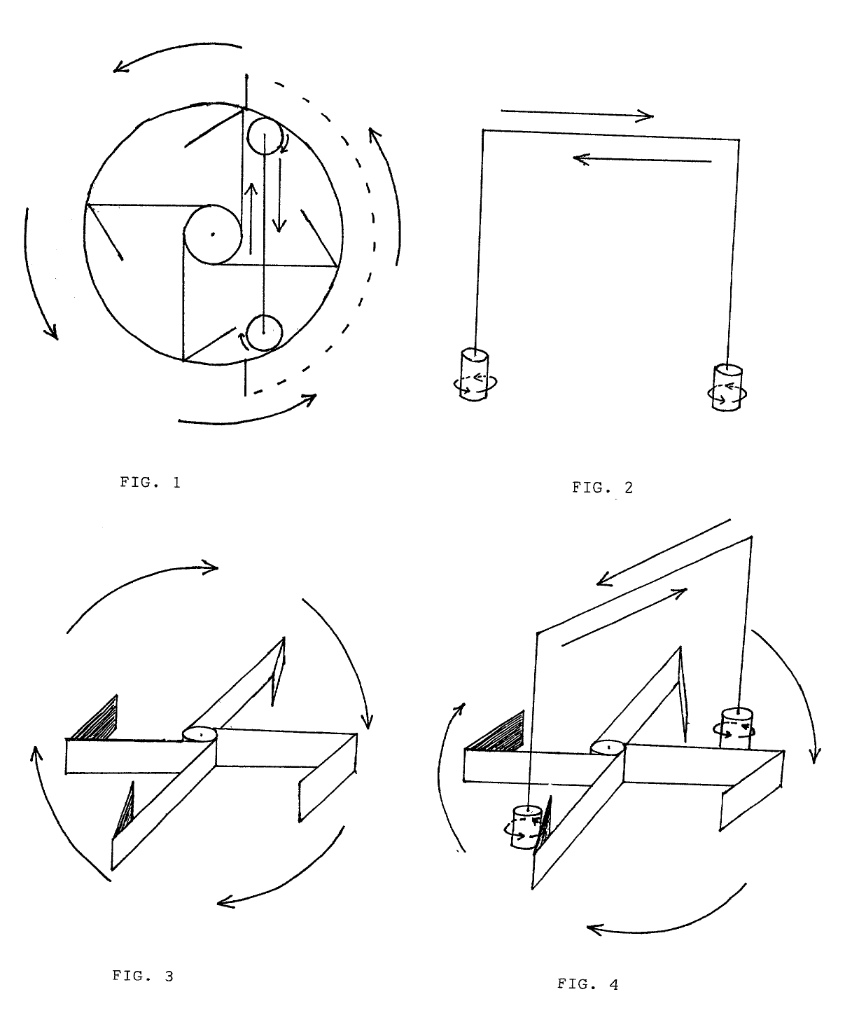

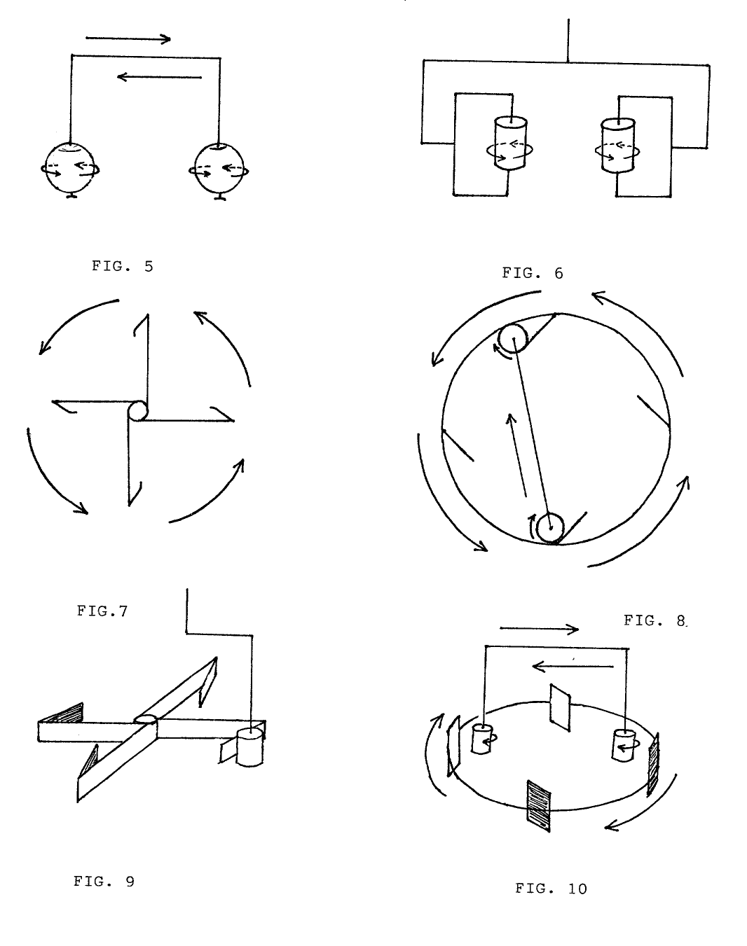

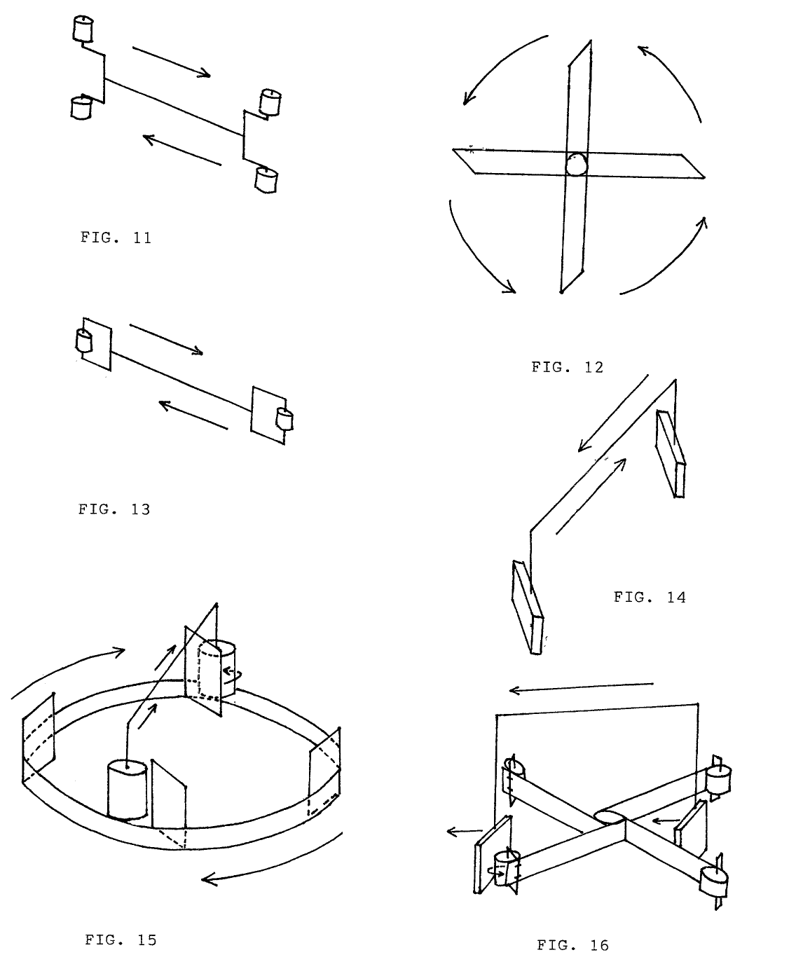

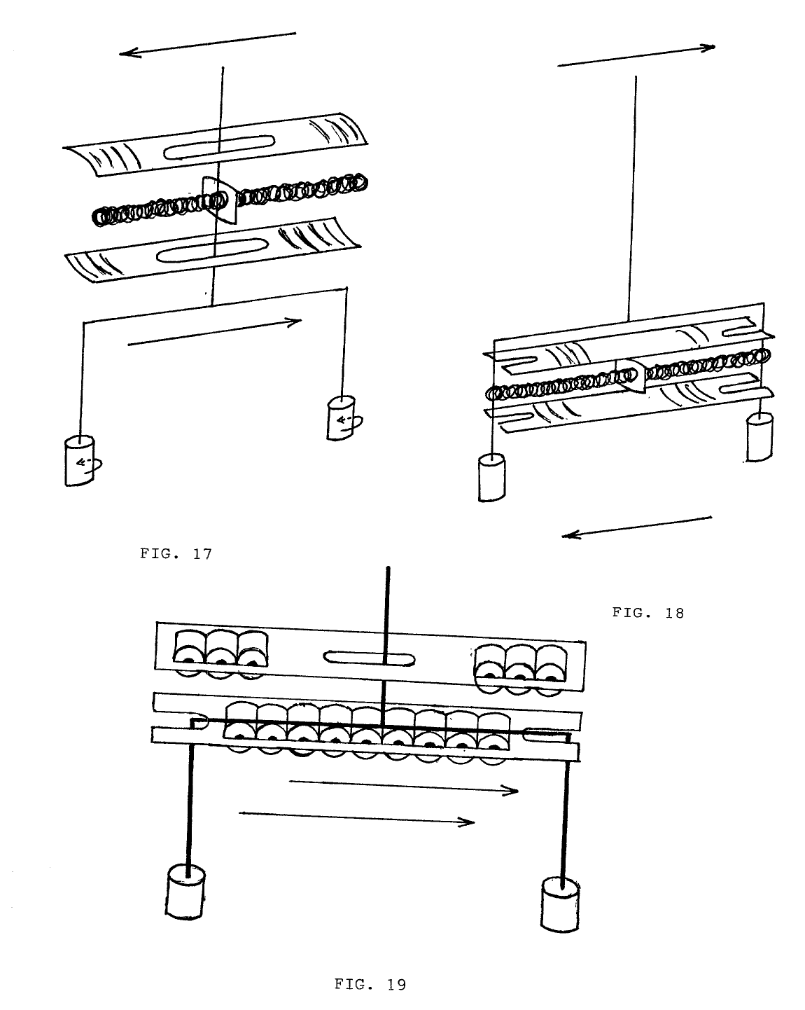

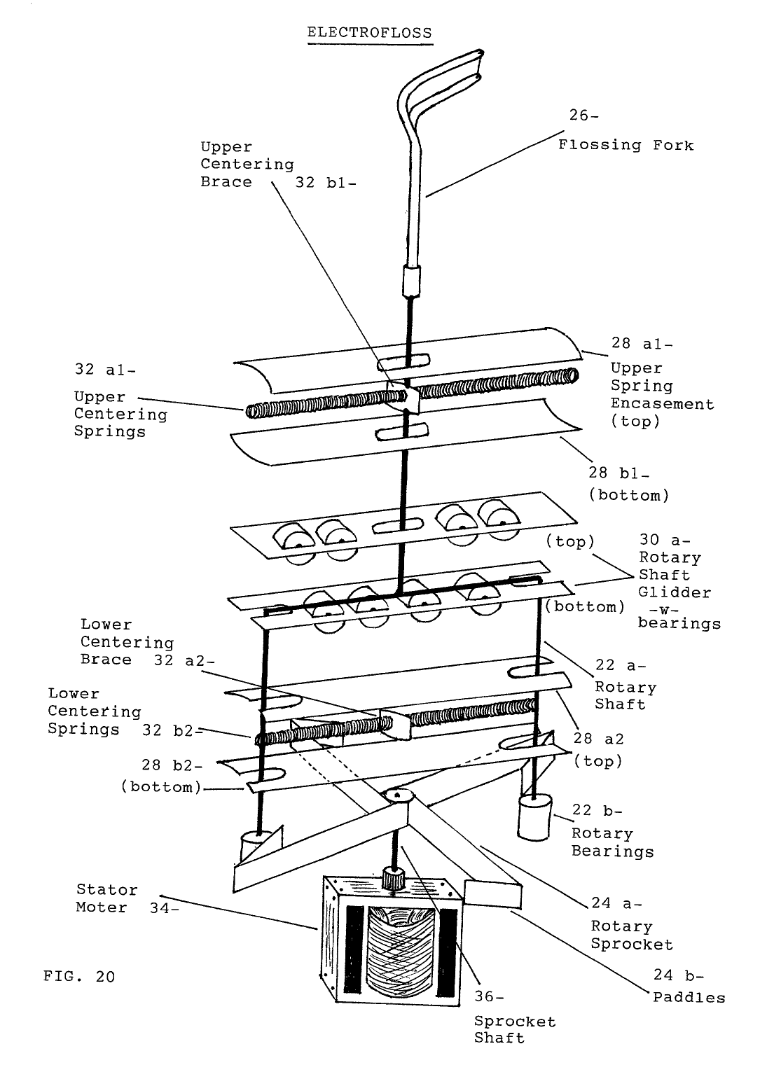

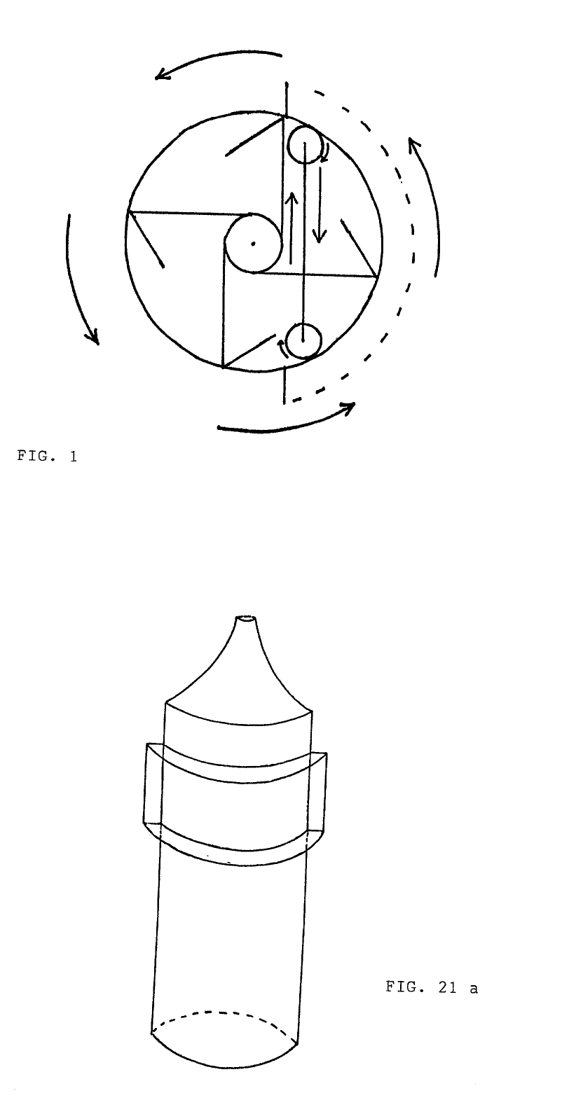

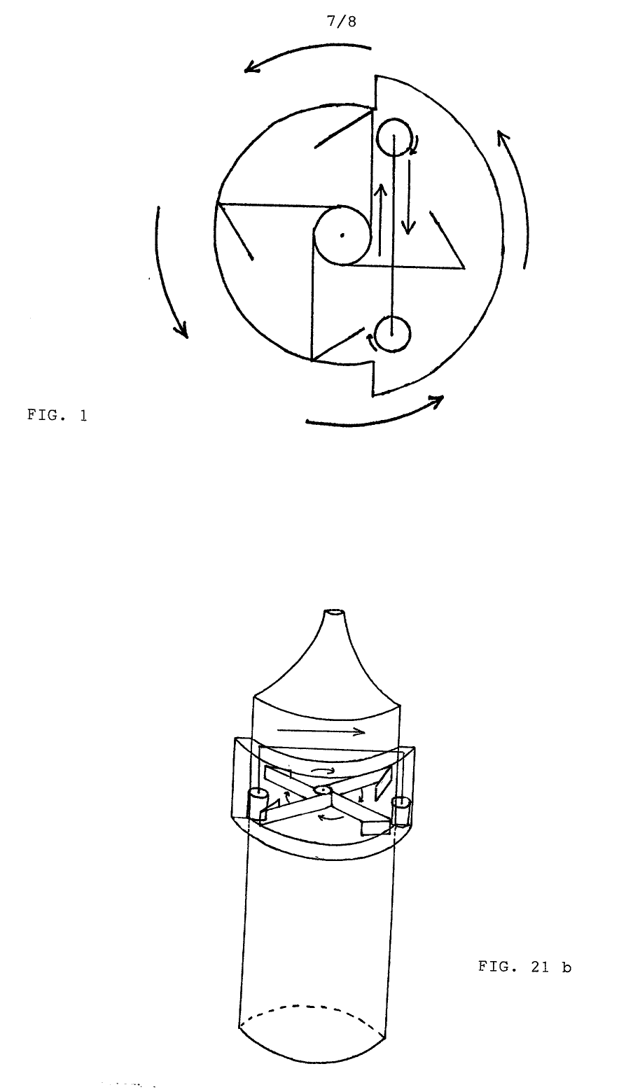

FIGS. 17 through 19 represent various components of a teeth-flossing devise whose function and mechanical make-up are dependent upon the said side to side-back and forth rotary devise described in FIGS. 1 through 4.

FIG. 17 shows said rotary shaft 22a and bearings 22b. Shown with 22a and 22b are upper centering springs 32b1, an upper centering brace 32a1, and an upper spring encasement 28a (top), and 28b (bottom). A centering spring 32b1, and centering brace 32a1 will serve as stabilizer for the said rotary shaft 22a as well as keep 22a properly aligned with the rotary sprocket 24a and paddles 24b while in operation and when not in operation. A centering brace 32a1 will serve as a brace and equalizer for 32b1. Each centering spring 32b1 will have equal tension. To keep the centering springs in place, an encasement 28a will secure the upper centering springs 32b1 in place.

FIG. 18 shows a lower centering brace 32a2 with lower centering springs 32b2 and lower spring encasement 28a2 (top) and 28b2 (bottom). The said parts in FIG. 18 will serve the same purpose as it's counterparts mentioned in FIG. 17. The parts described in FIG. 17 and FIG. 18 will give the rotary shaft 22a and bearings 22b the proper alignment and equalized stability needed to function properly.

FIG. 19 shows a shaft glider 30a with bearings 30a whose purpose is to give the rotary shaft 22a the ability to move smoothly and evenly from one direction to the other rapidly. The arrows indicate the direction in which the rotary shaft 22a is moving. It should be noted that ball bearings may be used in conjunction with 30a.

For the purpose of understanding how FIG. 20 operates, FIG. 20 shows an exploited view of Electrofloss.

FIG. 21a shows a version of an encasement that could be used to house the mechanical, teeth flossing devise, Electrofloss. FIG. 21a shows the general form of the encasement whose purpose is to house the components of Electrofloss. The scope of the encasement is not limited to the exact form shown in FIG. 21a. The scope of the said encasement should be manufactured so as to compliment the internal components and aid in proper functioning. Any changes in the design of the encasement can be determined by the manufacturer. In addition, the said encasement can be compared to the design form of the prior art for any necessary changes in the design of the said encasement.

FIG. 1 is shown on the same page with FIG. 21a for the purpose of showing the topical view of FIG. 21a while in operation.

FIG. 21a shows the said encasement that used to house the said side to side-back and forth rotary transmission device and the various said components.

FIG. 1 is shown again on the same page as FIG. 21a for the purpose of showing the relationship between the two said figures.

FIG. 21b shows the said encasement with the said side to side-back and forth rotary transmission devise housed within. The arrows indicate the direction of the moving components.

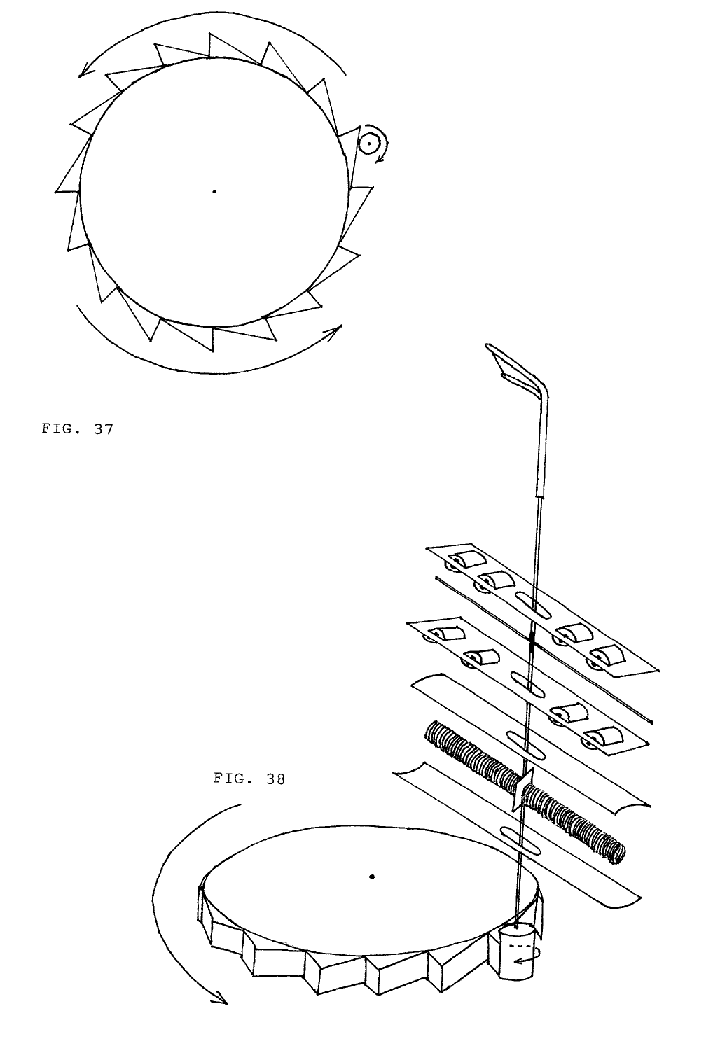

FIG. 37, a sprocket, represents the known prior art which can perform the same function as the said side to side-back and forth rotary transmission device. In FIG. 38, the said sprocket shown in FIG. 37 is shown in operation with a redesigned variation of Electrofloss. However, the said sprocket in FIG. 37 is inferior to the said rotary sprocket 24a and rotary paddles 24b. FIG. 37 cannot rotate an apparatus in a side to side motion as adequately as the said rotary sprocket 24a and rotary paddles 24b. FIG. 37 cannot make the rotary bearing 22b and rotary shaft 22a move side to side at the same speed. The rotary bearing 22b and rotary shaft 22a will move faster in one direction than it will in the opposite direction. In comparison, the said side to side-back and forth rotary transmission devise and its variations shown in FIGS. 1 through 16 can create a smooth and even side to side motion in which the rotary shaft 22a and rotary bearings 22b will move at the same speed in either direction, thereby more adequately performing its intended function.

### REFERENCE NUMERALS IN DRAWINGS

22a rotary shaft
22b rotary bearings
24a rotary sprocket
24b rotary paddles
(top)
26 flossing fork
(bottom)
28a1 upper spring encasement (top)
(bottom)
28b1 upper spring encasement (bottom)
28a2 lower spring encasement (top)
28b2 lower spring encasement (bottom)
30a rotary shaft glider
30b bearings
32a1 upper centering brace (top)
32b1. upper centering springs
32a2 lower centering brace
32b2 lower centering springs
34 stator motor
36 sprocket chaft

### OPERATION—FIGS. 1, 2, 3, 4, 20

FIGS. 1 through 4 represent the said side to side-back and forth rotary device which is an apparatus independent and separate from Electrofloss. Electrofloss, however, is dependent upon the said side to side-back and forth rotary devise covered in FIGS. 1 through 4. The said rotary device enables Electrofloss to perform the function for which it is intended.

FIG. 20 shows an exploded view of Electrofloss. For the purpose of flossing ones teeth adequately, Electrofloss requires a flossing fork 26. The said flossing fork 26 will be comprised of a two-pronged fork 26 with a piece of dental floss connected tightly between the two forks 26. During operation, the said flossing fork 26 will move rapidly back and forth. The user will angle the flossing fork 26 towards the space between any two teeth. Pushing into the gum line, the floss will loosen plaque and debris from the teeth and gums.

As previously stated in the description of FIGS. 17 through 19, the upper centering springs 32b, lower centering springs 32b2, and the rotary shaft glider 30a with bearings 30b will secure the rotary shaft 22a in place and enable the said rotary shaft 22a to operate properly. The upper centering springs 32b1 and lower centering springs 32b2 will have equal tension on each side for the purpose of keeping the bearings 22b synchronized with the paddles 24b of the rotary sprocket 24a.

The rotary sprocket 24a can be powered by a stator motor. In FIG. 20, the said rotary sprocket 24a is shown operating in a clockwise direction. The said rotary device can operate in the counter clockwise direction as well.

One of the said bearings 22b will be engaged with one of the four paddles 24b at all times. The rotary sprocket 24b and paddles 24b are not limited to four extensions and paddles for operation. More or less may be added.

As the stator motor 34 turns the rotary sprocket 24a, the engaged bearing 22b will roll up in an upwards direction on the connecting paddle 24b. The rotary shaft 22a will be aligned with the rotary sprocket 24a in a synchronized position which will enable the bearing 22b opposite the said engaged bearing 22b to engage with it's corresponding paddle 24b as soon as the said engaged bearing rolls off the back of it's connecting paddle 24b. This in turn will cause the flossing fork 26 to move in one direction or the other. This continuous process will be the means by which the said flossing fork 26 will move back and forth rapidly to accomplish it's intended function. Synchronized placement of the rotary shaft 22a and rotary sprocket 24a is necessary for proper operation. In FIGS. 21 and 22, synchronized placement is demonstrated.

The rotary shaft 22a is placed parallel with one of the arms of the rotary sprocket 24a. The circle 38 encasing the rotary shaft 22a and sprocket 24a in FIG. 1 serves as a guide for the purpose of assuring the proper dimensions and placement of the shaft 22a and rotary sprocket 24a. The components will be adjusted accordingly so as to achieve proper dimensions within the encasement as well as provide optimal performance.

I claim:

1. A method for separating a rotary transmission device whereby any attached apparatus will be caused to move in a side-to-side or back-and-forth motion comprising:
1. A shaft and rod worth bearings whereby the rod is attached at one end of the shaft member and the bearing attached at the opposite end of said shaft as shown in drawing FIGS. 1, 2, and 4.
2. A sprocket with angled levers attached at each end of the sprocket arms. The said are attached in the same side of each said lever's corresponding arm. The said shaft and rod with bearings shall be sandwitched within the said sprocket whereby one bearing shall be positioned on the side of one of the levers and the other bearing placed opposite the said first bearing, seated at the side of it's corresponding lever as shown in FIGS. 1 and 4.
3. The said sprocket is not limited to the demonstrating designs shown in FIG. 1. Other similar designs can be developed.
4. The said sprocket shall turn perpetually in a clock-wise direction or counter-clock-wise direction thus causing the engaged said bearing to glide up the said lever, rolling off of the back of said lever. As the said shaft moves back into it's stationary position, the opposite said bearing shall be engaged with the opposite said lever, thus rolling up the said opposite lever until it rolls off the back of the said lever. The shaft shall move back into stationary position whereby the process is repeated.
